(19) United States
(12) Patent Application Publication
(10) Pub. No.: US 2017/0096340 A1
(43) Pub. Date: Apr. 6, 2017

(54) METHOD FOR PRODUCING CARBON MATERIAL, AND CARBON MATERIAL

(71) Applicant: KABUSHIKI KAISHA KOBE SEIKO SHO ( KOBE STEEL, LTD.), Kobe-shi (JP)

(72) Inventors: Shohei WADA, Hyogo (JP); Maki HAMAGUCHI, Hyogo (JP)

(73) Assignee: KABUSHIKI KAISHA KOBE SEIKO SHO ( KOBE STEEL, LTD.), Kobe-shi (JP)

(21) Appl. No.: 15/310,863

(22) PCT Filed: May 19, 2015
(86) PCT No.: PCT/JP2015/064360

§ 371 Date: Nov. 14, 2016

(30) Foreign Application Priority Data
May 19, 2014 (JP) 2014-103837

(51) Int. Cl. C01B 31/04

(52) U.S. Cl. CPC C01B 31/04; C01B 31/02

(57) ABSTRACT

This method for producing a carbon material includes: a step of mixing an ashless coal, which is obtained by subjecting coal to a solvent extraction treatment, with an ashless coal coke, which is obtained by carbonizing an ashless coal; a step of heating and molding the obtained mixture; and a step of carbonizing the obtained molded body. In addition, the obtained carbon material contains ashless coal and has an optically anisotropic structure in which the proportion of the structure that is a coarse-grained mosaic or finer is 90% or higher.

### TECHNICAL FIELD

The present invention relates to a method for producing a carbon material, and a carbon material

### BACKGROUND ART

A carbon material is produced by forming a mixture of coke (aggregate) and pitch (binder) and carbonizing the formed body. In the production of such a carbon material, since a void is likely to remain in the formed body by one carbonization treatment, the carbon material after carbonization is generally impregnated with pitch and again carbonized. This carbonization process is often performed repeatedly.

The pitch or coke used in general as a raw material of the carbon material, both coal-derived and petroleum-derived, is not necessarily inexpensive. In addition, the petroleum-derived pitch has a problem that the content of impurities, such as sulfur content and metal content, is large. To cope with these problems, a method for producing a carbon material by using, as the binder, an ashless coal that is relatively inexpensive and contains little impurities (i.e., a low sulfur content and a low ash content), has been proposed (see, JP-A-2011-1240).

However, in the production method of a carbon material using an ashless coal, the ashless coal is heat-treated before forming. The deformability of the ashless coal is therefore poor, and a void remains in the obtained carbon material, as a result, the strength of the carbon material cannot be sufficiently increased.

### PRIOR ART LITERATURE

### Patent Document

Patent Document 1: JP-A-2011-1240

### SUMMARY OF THE INVENTION

### Problems that the Invention is to Solve

The present invention has been made under these circumstances, and an object of the present invention is to provide a carbon material being low-cost and excellent in the strength, and a production method thereof

### Means for Solving the Problems

As a result of intensive studies on the production method of a carbon material using an ashless coal, the present inventors have found that when an ashless coal coke produced from destructive distillation of an ashless coal is used as an aggregate and an ashless coal is used as a binder, the bending strength of the carbon material is remarkably enhanced. This is considered to be attributable to the fact, for example, that the carbon structure (optically anisotropic microstructure) of the ashless coal is composed of a mosaic microstructure having a size of not more than fine grain or that a molten ashless coal homogeneously fills a void between ashless coal cokes or a micropore of the ashless coal coke.

That is, the present invention for solving the above problems is directed to a method for producing a carbon material, including: a mixing step of mixing an ashless coal obtained by a solvent extraction treatment of coal and an ashless coal coke produced from destructive distillation of an ashless coal; a hot forming step of hot forming the mixture; and a carbonizing step of carbonizing the formed body.

In the production method of a carbon material, an ashless coal is used as a binder and an ashless coal coke is used as an aggregate, so that the impurity content can be reduced and the adhesive force can be increased by approximating the carbon structure of the aggregate to that of the binder. In the production method of a carbon material, the difference in the coefficient of thermal expansion between the aggregate and the binder is small and therefore, cracking due to distortion during heating is prevented. In the production method of a carbon material, a molten ashless coal homogeneously fills a void between ashless coal cokes or a micropore of the ashless coal coke, and the obtained carbon material has many fine or less isotropic mosaic microstructures. As a result, the carbon material obtained by the production method of a carbon material is low-cost and has high strength.

The content of the ashless coal in the mixture in the mixing step is preferably 5 mass % or more and 35 mass % or less. When the content of the ashless coal is within the range above, the expansion coefficient of the mixture can be appropriately controlled, and the density and strength of the obtained carbon material can be easily and unfailingly increased.

When the softening start temperature of the ashless coal is designated as T1 (° C.), the heating temperature of the mixture in the hot forming step is preferably not less than (T1+20° C.) and not more than 300° C. By heating the mixture at a temperature within the range above, the density and strength of the obtained carbon material can be easily and unfailingly increased. Here, the “softening start temperature” is a value measured in conformity with the Gieseler plastometer method of JIS-M8801:2004 and specifically, is an average temperature in the first one minute when a rotation at not less than one rotation per minute (1 ddpm) is continuously recognized for 2 minutes or more.

The carbonizing step preferably includes a step of carbonizing the formed body and a step of graphitizing the carbonized formed body. By performing carbonization and graphitization in this way, the strength of the carbon material can be more unfailingly increased.

Another aspect of the present invention invented to attain the object above is a carbon material containing an ashless coal obtained by a solvent extraction treatment of coal, wherein the proportion of a microstructure having a size of not more than coarse grain mosaic in an optically anisotropic microstructure is 90% or more. Thanks to a configuration where the carbon material contains an ashless coal and the proportion of the microstructure having a size of not more than coarse grain mosaic in an optically anisotropic microstructure is within the range above, the carbon material has high density and high strength, despite its low cost. Here, the optically anisotropic microstructure means the optically anisotropic microstructure described in Table 3.1.3 of “Tekko Gijutsu no Nagare (Trend of Iron and Steel Technology), Second Series, Vol. 12, “Coal-Coke”, Paragraph 77, 3.1 Quality Evaluation of Coke”. In addition, the “microstructure having a size of not more than coarse grain mosaic” means a microstructure where the size of the anisotropic unit dimension observed by a polarizing microscope is equal to or smaller than a coarse grain mosaic, and specifically indicates a microstructure where the size of the anisotropic unit dimension is less than 10 vim or a microstructure where an optically anisotropic microstructure is not observed.

The carbon material is preferably obtained by carbonizing a formed body obtained by hot forming a mixture of the ashless coal and an ashless coal coke produced from destructive distillation of an ashless coal. By this process, cost reduction and strength enhancement of the carbon material can be encouraged.

### Advantage of the Invention

As described above, in the production method of a carbon material of the present invention, a carbon material being low-cost and excellent in the strength can be obtained. In addition, the carbon material of the present invention is low-cost and excellent in the strength and therefore, can be suitably used as a structural member, an electric electronic component, a metal reducing agent, etc.

### BRIEF DESCRIPTION OF THE DRAWINGS

FIG. 1 A polarizing micrograph of a carbon material where a coal pitch is heat-treated at 1,000° C.

FIG. 2 A polarizing micrograph of a carbon material where an ashless coal and a coal pitch are mixed in a mass ratio of 20:80 and heat-treated at 1,000° C.

FIG. 3 A polarizing micrograph of a carbon material where an ashless coal and a coal pitch are mixed in a mass ratio of 60:40 and heat-treated at 1,000° C.

FIG. 4 A polarizing micrograph of a carbon material where an ashless coal is heat-treated at 1,000° C.

### MODE FOR CARRYING OUT THE INVENTION

The embodiment of the production method of a carbon material according to the present invention is described below.

The production method of a carbon material includes a step of mixing an ashless coal obtained by a solvent extraction treatment of coal and an ashless coal coke produced from destructive distillation of an ashless coal (mixing step), a step of hot forming the mixture (hot forming step), and a step of carbonizing the formed body (carbonizing step). The carbonizing step further includes a step of carbonizing the formed body (carbonization step) and a step of graphitizing the formed body which has been carbonized (graphitization step).

### <Mixing Step>

In the mixing step, an ashless coal and an ashless coal coke are mixed.

### (Ashless Coal)

The ashless coal (hypercoal, HPC) is a kind of modified coal obtained by modifying coal and is a modified coal after removing ashes and insoluble components as much as possible by using a solvent. The ash content of the ashless coal is generally 5 mass % or less, preferably 2 mass % or less. The upper limit of the ash content of the ashless coal is more preferably 5,000 ppm (mass bases), still more preferably 2,000 ppm. The raw material coal of the ashless coal used in the production method of a carbon material is preferably coal where when heated and ashed at 815° C., the concentration of the residual inorganic material (e.g., silicic acid, alumina, iron oxide, lime, magnesia, alkali metal) is very low. The ashless coal has a small water content of generally 0.5 mass % or less and exhibits higher thermal fluidity than the raw material coal. Here, the “ash content” means a value measured in conformity with JIS-M8812:2004.

### (Production Method of Ashless Coal)

The ashless coal can be obtained by various conventional production methods and can be obtained by removing the solvent from a solvent extract of coal. The ashless coal can be obtained, for example, by a production method including a slurry heating step, a separation step, and an ashless coal recovery step.

### [Slurry Heating Step]

In the slurry heating step, coal and an aromatic solvent are mixed to prepare a slurry, and the slurry is heat-treated to extract soluble components of the coal in the aromatic solvent. The kind of the raw material coal of the ashless coal is not particularly limited and, for example, various conventional coals such as bituminous coal, subbituminous coal, brown coal and lignite can be used. Among these, in view of profitability, a low-grade coal such as subbituminous coal, brown coal and lignite is preferred.

The aromatic solvent is not particularly limited as long as it is a solvent having a property of dissolving coal, and, for example, a monocyclic aromatic compound such as benzene, toluene and xylene, and a bicyclic aromatic compound such as naphthalene, methylnaphthalene, dimethylnaphthalene and trimethylnaphthalene, may be used. Examples of the bicyclic aromatic compound include aliphatic chain-containing naphthalenes and long-chain aliphatic chain-containing biphenyls.

Among the aromatic solvents above, a bicyclic aromatic compound that is a coal derivative refined from a destructive distillation product of coal, is preferred. The bicyclic aromatic compound as a coal derivative is stable even in a heated state and is excellent in the affinity for coal. Accordingly, when such a bicyclic aromatic compound is used as an aromatic solvent, the percentage of a coal component extracted in the solvent (hereinafter, sometimes referred to as “extraction percentage”) can be increased, and the solvent can be easily recovered by distillation or other methods and can be cyclically used.

The boiling point of the aromatic solvent is preferably 180° C. or more and 330° C. or less. If the boiling point of the aromatic compound is less than the lower limit above, during heating extraction, the extraction percentage may be decreased and a high pressure may be required. In addition, a high pressure may be required also in the later-described separation step, and the loss due to volatilization in the step of recovering the aromatic solvent may be increased, leading to a decrease in the recovery ratio of the aromatic solvent. Conversely, if the boiling point of the aromatic solvent exceeds the upper limit above, separation of the aromatic solvent from a liquid component or a solid component in the separation step is difficult, and the recovery ratio of the solvent decreases.

The lower limit of the mixing ratio of coal relative to the aromatic solvent in the slurry is, on the dry coal basis, preferably 10 mass %, more preferably 20 mass %. On the other hand, the upper limit of the mixing ratio is preferably 50 mass %, more preferably 35 mass %. If the mixing ratio is less than the lower limit above, the amount of a coal component extracted would be small for the amount of the aromatic solvent, and this is not profitable. Conversely, if the mixing ratio exceeds the upper limit above, the slurry viscosity would be increased, and transfer of the slurry or separation between a liquid component and a solid component in the separation step may become difficult.

The lower limit of the heat treatment temperature (extraction temperature) of the slurry is preferably 350° C., more preferably 380° C. On the other hand, the upper limit of the heat treatment temperature of the slurry is preferably 470° C., more preferably 450° C. If the heating temperature of the slurry is less than the lower limit above, the bonding between molecules constituting the coal cannot be sufficiently weakened and, for example, in the case of using a low-grade coal as the raw material coal, it may be impossible to elevate the resolidification temperature of the ashless coal recovered in the later-described ashless coal recovery step. Conversely, if the heat treatment temperature of the slurry exceeds the upper limit above, the pyrolytic reaction of the coal would become very active to cause recombination of pyrolytic radicals produced and in turn, the extraction percentage may be reduced.

The upper limit of the heating time (extraction time) of the slurry is preferably 120 minutes, more preferably 60 minutes, still more preferably 30 minutes. On the other hand, the lower limit of the heating time of the slurry is preferably 10 minutes. If the heating time of the slurry exceeds the upper limit above, the pyrolysis reaction of coal would proceed excessively, allowing for the progress of a radical polymerization reaction, and the extraction percentage may be reduced. Conversely, if the heating time of the slurry is less than the lower limit above, insufficient extraction of soluble components of the coal may result.

After the slurry is heated, the slurry is preferably cooled so as to suppress a pyrolysis reaction. The cooling temperature of the slurry is preferably 300° C. or more and 370° C. or less. If the cooling temperature of the slurry exceeds the upper limit above, a pyrolysis reaction may not be sufficiently suppressed. Conversely, if the cooling temperature of the slurry is less than the lower limit above, the dissolving power of the aromatic solvent would be reduced, causing reprecipitation of extracted coal components, and the recovery ratio of ashless coal may be decreased.

The heating extraction of the slurry is preferably performed in a non-oxidizing atmosphere. Specifically, the heating extraction of the slurry is preferably performed in the presence of an inert gas such as nitrogen. By using an inert gas such as nitrogen, contact of the slurry with oxygen to get ignition during heating extraction can be prevented at low cost.

The pressure during heating extraction of the slurry may vary depending on the heating temperature or the vapor pressure of the aromatic solvent used but may be, for example, 1 MPa or more and 2 MPa or less. If the pressure during heating extraction is lower than the vapor pressure of the aromatic solvent, the aromatic solvent would be vaporized, and soluble components of the coal cannot be confined in a liquid phase, and as a result, soluble components cannot be extracted. On the other hand, if the pressure during heating extraction is too high, the equipment cost, operation cost, etc. would rise.

### [Separation Step]

In the separation step, the slurry heat-treated in the slurry heating step is separated into a liquid component and a solid component. The liquid component is a solution moiety containing coal components extracted in the aromatic solvent. The solid component of the slurry is a moiety containing ashes and coal components insoluble in the aromatic solvent.

The method for separating the slurry into a liquid component and a solid component is not particularly limited, and a conventional separation method such as filtration method, centrifugal separation method and gravity settling method, may be employed. Among these, a gravity settling method enabling continuous operation of a fluid and being low-cost and suitable for mass processing is preferred. In the gravity settling method, a supernatant liquid as a liquid component containing coal components extracted in the aromatic solvent is separated to the upper part of a gravity settling tank, and a solid content concentrate containing solvent-insoluble ashes and coal components is separated as a solid component to the lower part of the gravity settling tank.

### [Ashless Coal Recovery Step]

In the ashless coal recovery step, the aromatic solvent is separated from the liquid component of the slurry obtained in the separation step, and an ashless coal having an extremely low ash content is recovered.

The method for separating the aromatic solvent from the liquid component of the slurry is not particularly limited, and a general distillation method, evaporation method (e.g., spray drying method), etc. can be used. The aromatic solvent separated and recovered can be cyclically used. By the separation of the aromatic solvent, an ashless coal is obtained from the liquid component.

In the production method of an ashless coal, various processing steps may be added. Specifically, as long as each of the steps above is not adversely affected, steps, for example, a step of pulverizing the raw material coal, a step of removing a foreign material, etc., and a step of drying the obtained ashless coal, may be provided between respective steps or before or after each step.

If desired, a byproduct coal with a concentrated ash content may be produced by separating the aromatic solvent from the solid component of the slurry. As to the method for separating the aromatic solvent from the solid component, a general distillation method or evaporation method can be used, similarly to the above-described method for obtaining an ashless coal from a liquid component.

The particle diameter of the ashless coal used in this process is not particularly limited, but the upper limit of the median diameter of the ashless coal is preferably 100 more preferably 50 μm. On the other hand, the lower limit of the median diameter of the ashless coal is preferably 1 more preferably 10 μm. If the median diameter of the ashless coal exceeds the upper limit above, the mixing state with the ashless coal coke would be non-uniform, which may cause, for example, forming failure of the mixture, or shortage of strength of the carbon material. Conversely, if the median diameter of the ashless coal is less than the lower limit above, the handling property or production efficiency may be reduced. Here, the “median diameter” means a particle diameter at a volume integrated value of 50% in the particle size distribution determined by a laser diffraction/scattering method.

In order to enhance the deformability of the ashless coal with the purpose of increasing the strength of the carbon material, the softening start temperature of the ashless coal must be lowered so as to prevent the decomposition reaction from becoming active even at a high temperature and not to produce a volatile matter. The upper limit of the softening start temperature Ti of the ashless coal is preferably 230° C., more preferably 200° C. If the softening start temperature Ti of the ashless coal exceeds the upper limit above, heating at a high temperature would be required to deform the ashless coal, allowing the decomposition reaction of the ashless coal to become active, and the density and strength of the obtained carbon material may be insufficient.

Examples of the method for lowering the softening start temperature of the ashless coal include, for example, a method of setting the extraction temperature to a high temperature, a method of adding an additive such as coal pitch to the ashless coal, and a method of using coal with low coalification degree, such as brown coal, for the raw material of the ashless coal.

In addition, by setting the median diameter of the ashless coal to be smaller than the median diameter of the ashless coal coke, the binder effect of the ashless coal can be increased.

### (Ashless Coal Coke)

The ashless coal coke (HPCC) is obtained by carbonizing an ashless coal, specifically, by heat-treating an ashless coal at a temperature of 600° C. or more and 1,000° C. or less in an inert atmosphere such as nitrogen. The heating temperature is set to fall within the range above, because expansibility of the ashless coal disappears around 500° C. In the production method of a carbon material, an ashless coal different from the ashless coal mixed with an ashless coal coke in the mixing step may be used as the raw material of the ashless coal coke.

The production method of the ashless coal coke is not particularly limited, and the production may be performed using a conventional carbonization technique. The temperature rise rate during heating may be, for example, 0.1° C./min or more and 5° C./min or less. The carbonization of the ashless coal may also be performed under pressure by using a hot isostatic pressing device, etc. A binder component such as asphalt pitch or tar may be added to the ashless coal, if desired, but for enhancing the effects of the present invention, it is preferable not to add such a binder component. In addition, an ashless coal may be appropriately formed and then subjected to carbonization. The heat treating furnace used for carbonization is not particularly limited, and a conventional furnace can be used. Examples of the heat treating furnace include, for example, a pot furnace, a Reidhammer furnace, a kiln, a rotary kiln, a shaft furnace, and a coke oven.

The median diameter of the ashless coal coke used in this process is not particularly limited, but the upper limit of the median diameter of the ashless coal coke is preferably 80 μm, more preferably 40 On the other hand, the lower limit of the median diameter of the ashless coal coke is preferably 1 μm, more preferably 10 μm. If the median diameter of the ashless coal coke exceeds the upper limit above, the inside of the ashless coal coke would not be sufficiently carbonized and, for example, shortage of strength of the carbon material may be caused. Conversely, if the median diameter of the ashless coal coke is less than the lower limit above, the handling property or production efficiency may be reduced.

### (Content of Ashless Coal)

The lower limit of the content of the ashless coal in the mixture is preferably 5 mass %, more preferably 10 mass %. On the other hand, the upper limit of the content of the ashless coal is preferably 35 mass %, more preferably 25 mass %. If the content of the ashless coal is less than the lower limit above, a binder component would run short, and the strength of the obtained carbon material may be insufficient. Conversely, if the content of the ashless coal exceeds the upper limit above, the expansion coefficient of the mixture would be increased and may affect the furnace body during carbonization of the mixture.

The method for mixing the ashless coal and the ashless coal coke is not particularly limited and, for example, a method where the ashless coal and the ashless coal coke are charged into a conventional mixer and stirred while pulverizing them by a conventional method, may be used. When this method is employed, a secondary particle formed by aggregation of the ashless coal or ashless coal coke can be pulverized and at the same time, the ashless coal or ashless coal coke can be pulverized in a granular form. The ashless coal and the ashless coal coke, which are previously pulverized, may also be mixed.

In the mixture of the ashless coal and the ashless coal coke, a binder or an aggregate, other than the ashless coal, may be mixed, if desired. Examples of the binder other than the ashless coal include, for example, petroleum pitch, and by adding the petroleum pitch, the melting point of the binder can be lowered. The upper limit of the mixing ratio of the binder other than the ashless coal, relative to the ashless coal, is preferably 50 mass %, more preferably 30 mass %. If the mixing ratio of the binder other than the ashless coal exceeds the upper limit above, the proportion of a coarse grain mosaic microstructure in the obtained carbon material would be reduced, and insufficient strength may result. In order to unfailingly produce the effects of the present invention, a mixture composed of the ashless coal and the ashless coal coke is preferably used.

### <Hot Forming Step>

In the hot forming step, the mixture of the ashless coal and the ashless coal coke is formed in a desired shape under heating. When the mixture is formed, the bonding between respective carbon materials can be made firmer by the binder effect of the ashless coal, and dusting of the carbon material or reduction in the bulk density can be suppressed.

The method for forming the mixture is not particularly limited and, for example, a forming method using a double roll (twin roll)-type forming machine with a flat roll, a double roll-type forming machine with an almond-shaped pocket, a press forming machine, an extrusion forming machine, etc. can be employed. Among them, it is preferred that a double roll-type forming machine is used to form the mixture into a briquette shaped or sheet shaped formed body.

In this hot forming step, hot forming of forming the mixture under heating is performed. When the mixture is formed under pressure at a high temperature in this way, the ashless coal is softened and then plastically deformed to fill a void between ashless coal cokes, so that a more dense formed body can be obtained.

When the softening start temperature of the ashless coal is designated as T1 (° C.), the lower limit of the heating temperature of the mixture in this hot forming step is preferably T1+20° C., more preferably T1+30° C. On the other hand, the upper limit of the heating temperature of the mixture is preferably 300° C., more preferably 280° C. If the heating temperature of the mixture is less than the lower limit above, the deformability of the ashless coal would be insufficient, and the carbon material may have an unsatisfied density. Conversely, if the heating temperature of the mixture exceeds the upper limit, the decomposition reaction of the ashless coal would become active, and the carbon material may have an unsatisfied density.

The forming pressure during forming is not particularly limited but may be, for example, 0.5 ton/cm² or more and 5 ton/cm² or less.

### <Carbonization Step>

The carbonization step is a step of carbonizing the formed body obtained in the forming step. The carbonization of the formed body is performed by heating the formed body in a non-oxidizing atmosphere. Specifically, the formed body is charged into an arbitrary heating device such as electric furnace and after replacing the inside with a non-oxidizing gas, heating is performed while blowing a non-oxidizing gas into the heating device. When heated, the ashless coal is softened, melted and resolidified, and a void of the ashless coal coke is filled with the ashless coal.

The heating temperature in the carbonization step may be appropriately set according to the properties required of the carbon material and is not particularly limited, but the lower limit of the heating temperature is preferably 500° C., more preferably 700° C. On the other hand, the upper limit of the heating temperature is preferably 3,000° C., more preferably 2,800° C. If the heating temperature is less than the lower limit above, insufficient carbonization may result. Conversely, if the heating temperature exceeds the upper limit above, the production cost may rise from the viewpoint of enhanced heat resistance or fuel consumption of the equipment. The temperature rise rate may be, for example, 0.01° C/min or more and PC/min or less.

The heating time in the carbonization step may also be appropriately set according to the properties required of the carbon material and is not particularly limited, but the heating time is preferably 0.5 hours or more and 10 hours or less. If the heating time is less than the lower limit above, insufficient carbonization may result. Conversely, if the heating time exceeds the upper limit above, the production efficiency of the carbon material may be reduced.

The non-oxidizing gas is not particularly limited as long as it can suppress oxidation of the carbon material, but an inert gas is preferred, and among inert gases, from an economical viewpoint, a nitrogen gas is more preferred.

### <Graphitization Step>

The graphitization step is a step of further graphitizing the formed body carbonized in the carbonization step. The graphitization of the formed body is performed by heating the formed body at a higher temperature than in the carbonization step, in the same non-oxidizing atmosphere as in the carbonization step. In the graphitization step, the same heating device as in the carbonization step can be used.

The heating temperature in the graphitization step may be appropriately set according to the properties required of the carbon material and is not particularly limited, but the lower limit of the heating temperature is preferably 2,000° C., more preferably 2,400° C. On the other hand, the upper limit of the heating temperature is preferably 3,000° C., more preferably 2,800° C. If the heating temperature is less than the lower limit above, insufficient graphitization may result. Conversely, if the heating temperature exceeds the upper limit above, the production cost may rise from the viewpoint of enhanced heat resistance or fuel consumption of the equipment. The temperature rise rate may be, for example, 0.01° C/min or more and 1° C/min or less.

The heating time in the graphitization step may also be appropriately set according to the properties required of the carbon material and is not particularly limited, but the heating time is preferably 0.5 hours or more and 10 hours or less. If the heating time is less than the lower limit above, insufficient graphitization may result. Conversely, if the heating time exceeds the upper limit above, the production efficiency of the carbon material may be reduced.

### <Carbon Material>

The thus-obtained carbon material has high purity and high density. The upper limit of the ash content of the carbon material is preferably 5,000 ppm, more preferably 3,000 ppm. The lower limit of the bulk density of the carbon material is preferably 1.5 g/ml, more preferably 1.6 g/ml, still more preferably 1.7 g/ml. When the ash content of the carbon material is not more than the upper limit above and the bulk density is not less than the lower limit above, the carbon material can be prevented from occurrence of crazing or cracking, and the shape of the formed body before carbonization can be maintained without expansion, deformation, dusting, etc.

In the carbon material, the proportion of a microstructure having a size of not more than coarse grain mosaic in an optically anisotropic microstructure is 90% or more. The lower limit of the proportion of the microstructure having a size of not more than coarse grain mosaic is more preferably 95%. Furthermore, in the carbon material, the proportion of the microstructure having a size of not more than coarse grain mosaic is preferably 100%, i.e., it is preferable not to contain fibrous, laminar and inert microstructures in an optically anisotropic structure. When the proportion of a microstructure having a size of not more than coarse grain mosaic is not less than the lower limit above or 100%, the carbon material has high strength as well as high density, because a coarse carbon microstructure is not contained and a dense and isotropic carbon structure is formed.

Here, the microstructure having a size of not more than coarse grain mosaic specifically means a coarse grain mosaic, a medium grain mosaic, a fine grain mosaic, and an isotropic or ultrafine grain mosaic. The “coarse grain mosaic” is a mosaic microstructure where the size of the anisotropic unit dimension observed by a polarizing microscope is 5 μm or more and less than 10 μm. The “medium grain mosaic” is a mosaic microstructure where the size of the anisotropic unit dimension is 1.5 μm or more and less than 5 μm. The “fine grain mosaic” is a mosaic microstructure where the size of the anisotropic unit dimension is less than 1.5 μm. The “isotropic or ultrafine grain mosaic” is a mosaic microstructure where an optically anisotropic microstructure is not observed. The “fibrous” means a fibrous microstructure having a long side of 10 μm or more and a width of less than 10 μm. The “laminar” means a plate-like microstructure where both the long side and the width are 10 μm or more. The “inert microstructure” is a microstructure composed of an inert component that is not softened/melted when heating the coal.

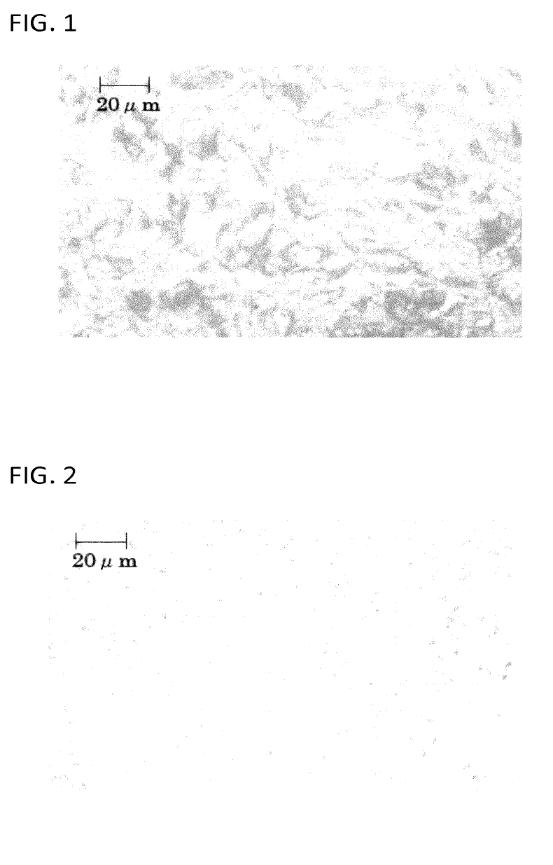

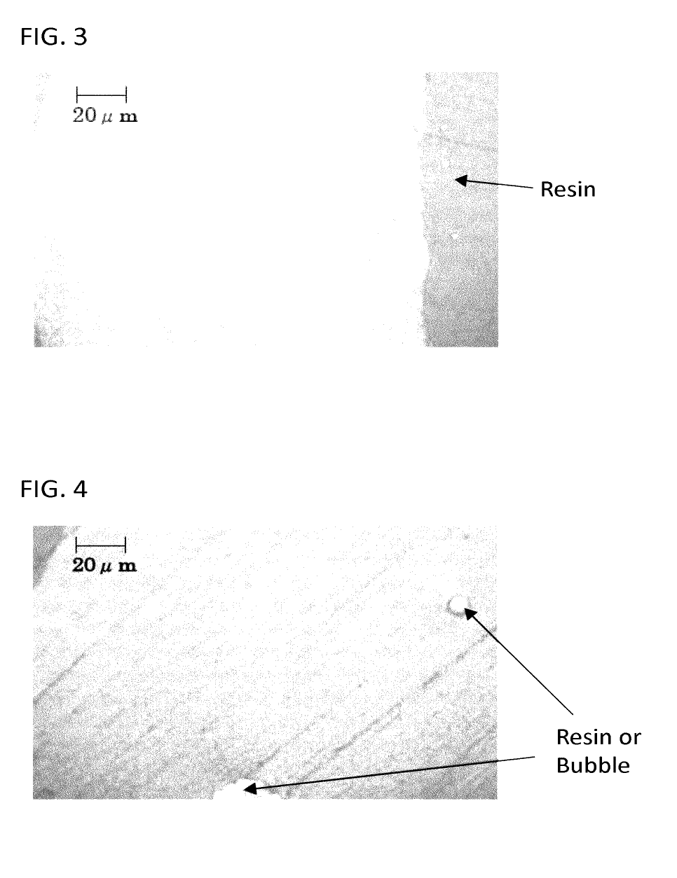

FIGS. 1 to 4 illustrate polarizing micrographs of a surface after a carbide obtained by carbonizing a coal pitch, a mixture of an ashless coal and a coal pitch, or an ashless coal at 1,000° C. is buried in a resin and then polished. FIG. 1 is a surface when carbonizing only a coal pitch; FIG. 2 is a surface when mixing an ashless coal and a coal pitch in a mass ratio of 20:80 and carbonizing the mixture; FIG. 3 is a surface when mixing an ashless coal and a coal pitch in a mass ratio of 60:40 and carbonizing the mixture; and FIG. 4 is a surface when carbonizing only an ashless coal. The ratio of microstructure components, obtained by observing the carbides of FIGS. 1 to 4, is shown in Table 1. As seen from these photographs and Table 1, when a coal pitch is carbonized, a flow structure having a size of not more than coarse grain mosaic occupies a majority, and a relatively large carbon microstructure is formed. On the other hand, when an ashless coal is mixed with a petroleum pitch, the microstructure is miniaturized in a mosaic pattern, and when an ashless coal is carbonized alone, the main part is a microstructure of a small size visually unrecognizable in the photograph of FIG. 4.

TABLE 1

| | Microstructure Components (%) | | | | | | |
|---|---|---|---|---|---|---|---|
| | Isotropic or | | | | | | |
| | ultrafine grain | Fine grain | Medium g rain | Coarse grain | | | Inert |
| Sample | mosaic | mosaic | mosaic | mosaic | Fibrous | Laminar | Microstructure |
| Coal pitch | 0.0 | 0.0 | 0.0 | 0.0 | 5.7 | 94.3 | 0.0 |
| (FIG. 1) | | | | | | | |
| Ashless coal and coal pitch | 0.0 | 0.0 | 55.7 | 22.9 | 2.1 | 19.3 | 0.0 |
| (mixing ratio: 20:80) | | | | | | | |
| (FIG. 2) | | | | | | | |
| Ashless coal and coal pitch | 1.2 | 93.3 | 5.5 | 0.0 | 0.0 | 0.0 | 0.0 |
| (mixing ratio: 60:40) | | | | | | | |
| (FIG. 3) | | | | | | | |
| Ashless coal | 4.6 | 95.4 | 0.0 | 0.0 | 0.0 | 0.0 | 0.0 |
| (FIG. 4) | | | | | | | |

### <Advantages>

In the production method of a carbon material, an ashless coal is used as a binder and an ashless coal coke is used as an aggregate, so that the impurity content can be reduced and the adhesive force can be increased by approximating the carbon structure of the aggregate to that of the binder. In the production method of a carbon material, the difference in the coefficient of thermal expansion between the aggregate and the binder is small and therefore, cracking due to distortion during heating is prevented. In the production method of a carbon material, a molten ashless coal homogeneously fills a void between ashless coal cokes or a micropore of the ashless coal coke, and the obtained carbon material has many fine or less isotropic mosaic microstructures. As a result, the carbon material obtained by the production method of a carbon material is low-cost and has high strength.

### EXAMPLES

The present invention is described in greater detail below by referring to Examples, but the present invention is not limited these Examples.

### <Production of Ashless Coal>

An ashless coal was produced by the following method. First, a bituminous coal produced in Australia was prepared as the raw material coal of the ashless coal, and 5 kg (mass in terms of dry coal) of the raw material coal and a four-fold amount (20 kg) of 1-methylnaphthalene (produced by Nippon Steel Chemical Co., Ltd.) as a solvent were mixed to prepare a slurry. The slurry was put in a batch autoclave having an inner volume of 30 L, pressurized to 1.2 MPa by introducing nitrogen, and heated at 400° C. for one hour. The resulting slurry was separated into a supernatant liquid and a solid content concentrate in a gravity settling tank maintained at the above-described temperature and pressure, and the solvent was separated and recovered from the supernatant liquid by a distillation method to obtain 2.7 kg of Ashless Coal A. The softening start temperature of Ashless Coal A as measured in conformity with the Gieseler plastometer method of JIS-M8801:2004 was 220° C.

Ashless Coal B was produced on the same conditions as Ashless Coal A except for changing the heating temperature (extraction temperature) to 430° C. The softening start temperature of Ashless Coal B was 195° C.

### <Production of Ashless Coal Coke>

Ashless Coal B was put in a heating furnace and heated and carbonized at 1,000° C. for 60 minutes in a nitrogen atmosphere to obtain an ashless coal coke.

### Examples 1 to 6 and Comparative Examples 1 to 6

Carbon materials of Examples 1 to 6 and Comparative Examples 1 to 6 were obtained by the following procedure. First, a binder and an aggregate were used as shown in Table 2 and mixed such that the content of the binder becomes the value shown in Table 2, to obtain a mixture. The “coal pitch” in the column of Binder is a commercially available coal pitch having a softening start temperature of 100° C. or less. The “ashless coal mixture” is a mixture prepared by mixing Ashless Coal B and the coal pitch above in a mass ratio of 60:40, and the softening start temperature thereof was 177° C. The “coal-based coke” in the column of Aggregate is an aggregate obtained by carbonizing a commercially available coal-based green coke at 1,000° C. Each of Ashless Coal A, Ashless Coal B and the ashless coal coke was used after pulverization to a median diameter of 45 μm or less.

The mixture obtained above was put in a die and hot formed at 250° C. under a pressure of 3 ton/cm² to obtain a formed body.

The formed body was put in a heating furnace and heated at 1,000° C. for 120 minutes in a nitrogen atmosphere, thereby performing carbonization. The carbonized formed body was put in a heating furnace and graphitized by heating the formed body at 2,500° C. for 120 minutes in a nitrogen atmosphere to obtain a carbon material.

### (Evaluation)

With respect to the carbon materials of Examples 1 to 6 and Comparative Examples 1 to 6, the bulk density after forming but before carbonization and the bulk density after graphitization were measured in conformity with JIS-K2151:2004. In addition, the bending strength of the obtained carbon material was measured in conformity with JIS-R7222:1997 and evaluated according to the following criteria. These results are shown in Table 2.

A: The bending strength is 50 MPa or more.

B: The bending strength is 46 MPa or more and less than 50 MPa.

C: The bending strength is 42 MPa or more and less than 46 MPa.

D: The bending strength is less than 42 MPa.

TABLE 2

| | | | Binder | Bulk Density | Bulk Density After | Bending Strength | |
|---|---|---|---|---|---|---|---|
| | | | Content | After Forming | Graphitization | After Graphitization | |
| | Binder | Aggregate | mass % | g/cm³ | g/cm³ | MPa | Evaluation |
| Example 1 | Ashless Coal A | ashless coal coke | 18 | 1.25 | 1.68 | 52 | A |
| Example 2 | Ashless Coal B | ashless coal coke | 15 | 1.24 | 1.67 | 51 | A |
| Example 3 | ashless coal mixture | ashless coal coke | 12 | 1.20 | 1.63 | 46 | B |
| Example 4 | Ashless Coal A | ashless coal coke | 28 | 1.21 | 1.63 | 46 | B |
| Example 5 | Ashless Coal B | ashless coal coke | 25 | 1.19 | 1.62 | 47 | B |
| Example 6 | ashless coal mixture | ashless coal coke | 22 | 1.24 | 1.65 | 49 | B |
| Comparative | Ashless Coal B | coal-based coke | 25 | 1.21 | 1.62 | 44 | C |
| Example 1 | | | | | | | |
| Comparative | ashless coal mixture | coal-based coke | 22 | 1.22 | 1.63 | 44 | C |
| Example 2 | | | | | | | |
| Comparative | coal pitch | ashless coal coke | 20 | 1.19 | 1.62 | 41 | D |
| Example 3 | | | | | | | |
| Comparative | coal pitch | ashless coal coke | 25 | 1.24 | 1.67 | 45 | C |
| Example 4 | | | | | | | |
| Comparative | coal pitch | coal-based coke | 20 | 1.20 | 1.63 | 38 | D |
| Example 5 | | | | | | | |
| Comparative | coal pitch | coal-based coke | 25 | 1.26 | 1.67 | 42 | C |
| Example 6 | | | | | | | |

As seen from Table 2, in Examples 1 to 6 where Ashless Coal A, B or a ashless coal mixture containing Ashless Coal B was used as the binder and an ashless coal coke is used as the aggregate, the carbon material has a high bending strength of 46 MPa or more. On the other hand, in all of Comparative Examples 1 to 6 where a coal-based coke was used as the aggregate or a coal pitch was used as the binder, the bending strength was low and less than 46 MPa. Among others, in Comparative Examples 5 and 6 where an ashless coal was not contained at all, even when the amount of the binder was increased, the bending strength was 42 MPa at the maximum.

It is understood from the results of Table 2 that when only an ashless coal is used as the binder and the content of the ashless coal in the mixture is 20 mass % or less, high bulk density and high bending strength are obtained (Examples 1 and 2).

While the invention has been described in detail and with reference to specific embodiments thereof, it will be apparent to one skilled in the art that various changes and modifications can be made therein without departing from the spirit and scope of the invention.

This application is based on Japanese Patent Application (Patent Application No. 2014-103837) filed on May 19, 2014, the contents of which are incorporated herein by way of reference.

### INDUSTRIAL APPLICABILITY

As described in the foregoing pages, according o the production method of a carbon material of the present invention, a carbon material being low-cost and excellent in the strength can be obtained. Such a carbon material can be suitably used as a structural member, an electric electronic component, a metal reducing agent, etc.

1. A method for producing a carbon material, the method comprising:
mixing an ashless coal obtained by a solvent extraction treatment of coal and an ashless coal coke produced from destructive distillation of an ashless coal, thereby obtaining a mixture,
hot forming the mixture, thereby obtaining a formed body, and
carbonizing the formed body.

2. The method according to claim 1, wherein a content of the ashless coal in the mixture in said mixing is 5 mass % or more and 35 mass % or less.

3. The method according to claim 1, wherein a heating temperature of the mixture in said hot forming is not less than (T1+20)° C. and not more than 300° C., where T1 is a softening start temperature of the ashless coal.

4. The method according to claim 1, wherein said carbonizing further comprises: graphitizing the formed body which has been carbonized.

5. A carbon material, comprising:
an ashless coal obtained by a solvent extraction treatment of coal,
wherein a proportion of a microstructure having a size of not more than coarse grain mosaic in an optically anisotropic microstructure is 90% or more.

6. The carbon material according to claim 5, obtained by a process comprising:
carbonizing a formed body obtained by hot forming a mixture of the ashless coal and an ashless coal coke produced from destructive distillation of an ashless coal.

7. The method according to claim 2, wherein a heating temperature of the mixture in said hot forming is not less than (T1+20)° C. and not more than 300° C., where T1 is a softening start temperature of the ashless coal.
